(19) United States
(12) Patent Application Publication
(10) Pub. No.: US 2026/0360642 A1
(43) Pub. Date: Nov. 12, 2026

(54) CIRCUIT BREAKER DEVICE

(71) Applicants: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(72) Inventors: Akira DAIBO, Kokubunji Tokyo (JP); Yoshimitsu NIWA, Fuchu Tokyo (JP); Keisuke UDAGAWA, Urayasu Chiba (JP); Junichi KONDO, Kokubunji Tokyo (JP); Naoki ASARI, Fuchu Tokyo (JP)

(73) Assignees: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(21) Appl. No.: 19/451,393

(22) Filed: Jan. 16, 2026

Related U.S. Application Data
(63) Continuation of application No. PCT/JP2023/042164, filed on Nov. 24, 2023.

(30) Foreign Application Priority Data
Aug. 8, 2023 (JP) 2023-129329

(51) Int. Cl. H01H 33/664; H01H 33/666

(52) U.S. Cl. CPC H01H 33/664; H01H 33/666

(57) ABSTRACT

There is provided a circuit breaker device having sufficient dielectric withstand capability and current-carrying performance even when using a vacuum circuit breaker. In the circuit breaker device in an embodiment, a first interrupting contact is connected in parallel with a current-carrying contact. A second interrupting contact is connected in parallel with the current-carrying contact and also connected in series with the first interrupting contact. A resistance of the current-carrying contact is smaller than a resistance of the first interrupting contact and a resistance of the second interrupting contact. In a current-carrying state, the current-carrying contact, the first interrupting contact, and the second interrupting contact are in a closed state, and a larger current flows through the current-carrying contact than through the first interrupting contact and the second interrupting contact. In an interrupted state, the first interrupting contact and the second interrupting contact switch from the closed state to an open state after the current-carrying contact switches from the closed state to the open state. At least one of the first interrupting contact and the second interrupting contact is constituted by a vacuum circuit breaker in which the closed state and the open state are switched inside a vacuum vessel.

### CROSSREFERENCE TO RELATED APPLICATIONS

This application claims priority to Japanese Patent Application No. 2023-129329, filed on Aug. 8, 2023, and is related to International Patent Application No. PCT/JP2023/042164, filed on Nov. 24, 2023, the entire contents of each of which are incorporated herein by reference.

### FIELD

Embodiments of the present invention relate to a circuit breaker device.

### BACKGROUND

In order to switch a current-carrying electric circuit from a current-carrying state to an interrupted state when an accident occurs in an electric power system, circuit breaker devices such as vacuum circuit breakers and gas circuit breakers have been used.

The vacuum circuit breaker houses, for example, a pair of contacts inside a vacuum vessel that is in a vacuum state. In the vacuum circuit breaker, in the current-carrying state, a contact state is established between the contacts in a pair under a vacuum atmosphere, and in the interrupted state, a separate state is established between the contacts in a pair under a vacuum atmosphere.

The gas circuit breaker houses, for example, a pair of contacts inside a grounded vessel filled with an insulating gas. In the gas circuit breaker, in the current-carrying state, a contact state is established between the contacts in a pair under an atmosphere filled with an insulating gas, and in the interrupted state, a separate state is established between the contacts in a pair under an atmosphere filled with an insulating gas. The gas circuit breaker has been configured to, in order to extinguish the arc discharge to occur during an interrupting operation, which switches from the current-carrying state to the interrupted state, blow the insulating gas onto the arc discharge, for example.

In the gas circuit breaker, SF₆ gas (sulfur hexafluoride gas) has been mainly used as the insulating gas to sufficiently obtain performances such as insulation performance and arc-extinguishing performance. Since having excellent performances such as insulation performance and arc-extinguishing performance, the gas circuit breaker can be suitably used for the electric circuit (such as a power transmission class electric circuit) to which a higher voltage is applied than the electric circuit interrupted by the vacuum circuit breaker.

The SF₆ gas, which has been mainly used as the insulating gas in the gas circuit breaker, has a high global warming potential. For this reason, the techniques using insulating gases other than the SF₆ gas have been proposed, but they have difficulty in obtaining sufficient performance.

Further, when applying the vacuum circuit breaker to the electric circuit to which a higher voltage is applied (power transmission class electric circuit), it is necessary to further improve dielectric withstand capability and current-carrying performance in the vacuum circuit breaker. However, in order to improve the dielectric withstand capability of the vacuum circuit breaker, it is necessary to increase the distance between a movable electrode and a fixed electrode that constitute the pair of contacts. Further, in order to improve the current-carrying performance of the vacuum circuit breaker, it is necessary to thicken the movable current-carrying shaft on which the movable electrode is provided. For this reason, it is difficult to switch from a closed state to an open state at a higher speed during the interrupting operation in the vacuum circuit breaker.

Due to such circumstances as described above, when using the vacuum circuit breaker in place of the gas circuit breaker using an insulating gas such as SF₆ gas, it is not easy to improve the dielectric withstand capability and the current-carrying performance.

Therefore, an object to be solved by the present invention is to provide a circuit breaker device that has sufficient dielectric withstand capability and current-carrying performance, even when a vacuum circuit breaker is used.

### BRIEF DESCRIPTION OF THE DRAWINGS

FIG. 1 is a circuit diagram of a circuit breaker device 100 according to a first embodiment.

FIG. 2 is a cross-sectional view schematically illustrating a configuration of the circuit breaker device 100 according to the first embodiment.

FIG. 3A is a circuit diagram illustrating an operation of the circuit breaker device 100 according to the first embodiment.

FIG. 3B is a circuit diagram illustrating the operation of the circuit breaker device 100 according to the first embodiment.

FIG. 4 is a cross-sectional view schematically illustrating a configuration of a circuit breaker device 100 according to a second embodiment.

FIG. 5 is a cross-sectional view illustrating a detailed configuration of a gas circuit breaker 251 in the circuit breaker device 100 according to the second embodiment.

FIG. 6A is a view illustrating an operation of the gas circuit breaker 251 in the circuit breaker device 100 according to the second embodiment.

FIG. 6B is a view illustrating the operation of the gas circuit breaker 251 in the circuit breaker device 100 according to the second embodiment.

FIG. 6C is a view illustrating the operation of the gas circuit breaker 251 in the circuit breaker device 100 according to the second embodiment.

FIG. 7 is a cross-sectional view schematically illustrating a configuration of a vacuum circuit breaker 211 in a circuit breaker device 100 according to a third embodiment.

FIG. 8 is a cross-sectional view schematically illustrating a configuration of a vacuum circuit breaker 211 in a circuit breaker device 100 according to a modified example of the third embodiment.

FIG. 9 is a cross-sectional view schematically illustrating a configuration of a circuit breaker device 100 according to a fourth embodiment.

FIG. 10 is a cross-sectional view schematically illustrating a configuration of a circuit breaker device 100 according to a fifth embodiment.

FIG. 11 is a cross-sectional view schematically illustrating a configuration of a circuit breaker device 100 according to a sixth embodiment.

FIG. 12 is a cross-sectional view schematically illustrating a configuration of a circuit breaker device 100 according to a modified example of the sixth embodiment.

### DETAILED DESCRIPTION

### Means for Solving the Problems

A circuit breaker device in an embodiment is a device for switching an electric circuit from a current-carrying state to an interrupted state, and the device includes: a current-carrying contact; a first interrupting contact; and a second interrupting contact. The first interrupting contact is connected in parallel with the current-carrying contact. The second interrupting contact is connected in parallel with the current-carrying contact and also connected in series with the first interrupting contact. A resistance of the current-carrying contact is smaller than a resistance of the first interrupting contact and a resistance of the second interrupting contact. In the current-carrying state, the current-carrying contact, the first interrupting contact, and the second interrupting contact are in a closed state, and a larger current flows through the current-carrying contact than through the first interrupting contact and the second interrupting contact. In the interrupted state, the first interrupting contact and the second interrupting contact are configured to switch from the closed state to an open state after the current-carrying contact switches from the closed state to the open state. At least one of the first interrupting contact and the second interrupting contact is constituted by a vacuum circuit breaker in which the closed state and the open state are switched inside a vacuum vessel.

### First Embodiment

### [A] Circuit of a Circuit Breaker Device 100

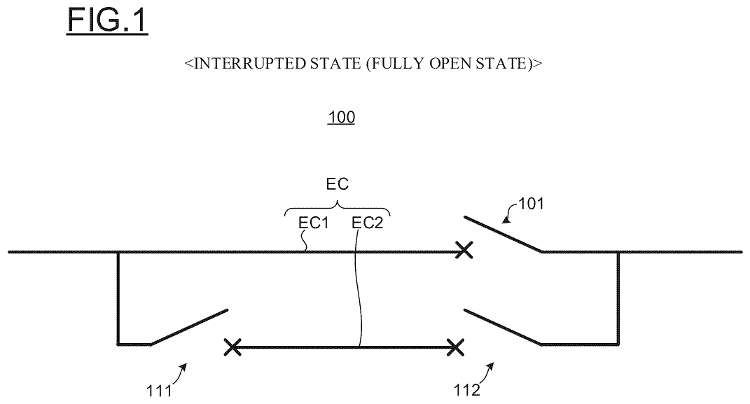

FIG. 1 is a circuit diagram of a circuit breaker device 100 according to a first embodiment.

As illustrated in FIG. 1, the circuit breaker device 100 in this embodiment is a device including a current-carrying contact 101, a first interrupting contact 111, and a second interrupting contact 112, and is installed in an electric circuit EC and configured to switch the electric circuit EC from a current-carrying state to an interrupted state. Here, the circuit breaker device 100 includes a current-carrying electric circuit EC1 and an interrupting electric circuit EC2 as the electric circuit EC, and the interrupting electric circuit EC2 is connected in parallel with the current-carrying electric circuit EC1 so as to bypass the current-carrying contact 101.

There will be explained respective parts constituting the circuit breaker device 100 in order below. Incidentally, FIG. 1 illustrates the state where the circuit breaker device 100 has switched the electric circuit EC to the interrupted state.

### [A-1] Current-Carrying Contact 101

The current-carrying contact 101 is installed in the current-carrying electric circuit EC1. The current-carrying contact 101 is configured to have a resistance smaller than that of the first interrupting contact 111 and the second interrupting contact 112. For example, the current-carrying contact 101 is configured using a conductive material that has a larger current-carrying cross-sectional area and a higher conductivity than the first interrupting contact 111 and the second interrupting contact 112.

### [A-2] First Interrupting Contact 111

The first interrupting contact 111 is installed in the interrupting electric circuit EC2 so as to be connected in parallel with the current-carrying contact 101.

### [A-3] Second Interrupting Contact 112

The second interrupting contact 112 is installed in the interrupting electric circuit EC2 so as to be connected in parallel with the current-carrying contact 101 and also connected in series with the first interrupting contact 111.

### [B] Configuration of the Circuit Breaker Device 100

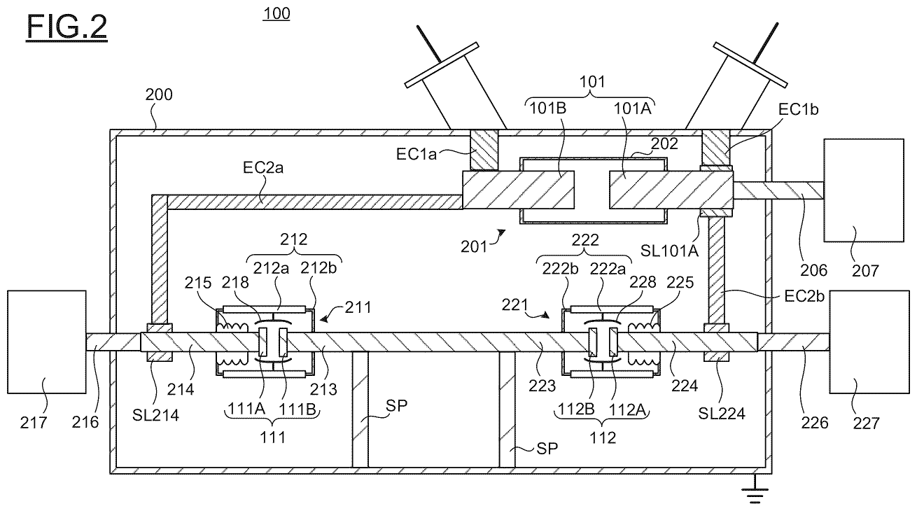

FIG. 2 is a cross-sectional view schematically illustrating the configuration of the circuit breaker device 100 according to the first embodiment.

As illustrated in FIG. 2, the circuit breaker device 100 in this embodiment houses a gas circuit breaker 201, a vacuum circuit breaker 211 (a first vacuum circuit breaker), and a vacuum circuit breaker 221 (a second vacuum circuit breaker) inside a grounded tank 200. Each of the parts constituting the circuit breaker device 100 will be explained in order.

### [B-1] Grounded Tank 200

The grounded tank 200 is formed of a metal material and is electrically connected to a reference potential point (such as ground).

### [B-2] Gas Circuit Breaker 201

The gas circuit breaker 201 houses, inside an insulating gas vessel 202, a gas circuit breaker movable electrode 101A and a gas circuit breaker fixed electrode 101B as the current-carrying contact 101. The gas circuit breaker 201 is configured so that the current-carrying contact 101 switches between a closed state and an open state inside the insulating gas vessel 202.

Here, the insulating gas vessel 202 is formed of an insulating material and is filled with an insulating gas. Here, the insulating gas is, for example, a gas having a global warming potential lower than that of the SF₆ gas, but may also be the SF₆ gas. Insulating gases having a global warming potential lower than that of the SF₆ gas include, for example, gases such as carbon dioxide, oxygen, and nitrogen, and a mixed gas of the gases described above.

The gas circuit breaker movable electrode 101A and the gas circuit breaker fixed electrode 101B are formed of a metal material and are installed so as to have their ends face each other inside the insulating gas vessel 202. The gas circuit breaker movable electrode 101A is slidably supported by a sliding part SL101A. The gas circuit breaker fixed electrode 101B is connected to an electric wire EC1a, and the gas circuit breaker movable electrode 101A is connected to an electric wire EC1b via the sliding part SL101A. The electric wire EC1a and the electric wire EC1b constitute the current-carrying electric circuit EC1 (see FIG. 1).

Further, the gas circuit breaker movable electrode 101A is connected to an operating mechanism 207 via an insulating rod 206. The gas circuit breaker 201 enters the closed state by establishing a contact state between the gas circuit breaker movable electrode 101A and the gas circuit breaker fixed electrode 101B by the operation of the operating mechanism 207. Along with this, the gas circuit breaker 201 enters the open state by establishing a separate state between the gas circuit breaker movable electrode 101A and the gas circuit breaker fixed electrode 101B by the operation of the operating mechanism 207.

### [B-3] Vacuum Circuit Breaker 211

The vacuum circuit breaker 211 is a vacuum valve, and houses a movable electrode 111A (a first movable electrode) and a fixed electrode 111B (a first fixed electrode) as the first interrupting contact 111 inside a vacuum vessel 212. The vacuum circuit breaker 211 is configured so that the first interrupting contact 111 switches between the closed state and the open state inside the vacuum vessel 212.

Here, the vacuum vessel 212 includes an insulating tube 212a and a pair of flanges 212b, and for example, the flanges 212b in a pair are installed at both ends of the cylindrical tubular insulating tube 212a respectively. The insulating tube 212a is formed of an insulating material (such as, ceramic), and the pair of flanges 212b is formed of, for example, a metal material. The inside of the vacuum vessel 212 is in a vacuum state, where the pressure inside the vacuum vessel 212 is lower than that inside the grounded tank 200.

The movable electrode 111A and the fixed electrode 111B are formed of a metal material and are installed so as to have their ends face each other inside the vacuum vessel 212. Here, the movable electrode 111A is installed at an end of a vacuum circuit breaker movable current-carrying shaft 214 (a first vacuum circuit breaker movable current-carrying shaft). Then, the fixed electrode 111B is installed at an end of a vacuum circuit breaker fixed current-carrying shaft 213 (a first vacuum circuit breaker fixed current-carrying shaft). The vacuum circuit breaker fixed current-carrying shaft 213 is installed so as to be aligned coaxially with the vacuum circuit breaker movable current-carrying shaft 214. The vacuum circuit breaker fixed current-carrying shaft 213 is supported by a support SP formed of an insulating material.

Further, the vacuum circuit breaker movable current-carrying shaft 214 is connected to an operating mechanism 217 via an insulating rod 216. The vacuum circuit breaker 211 enters, by the operation of the operating mechanism 217, the closed state by establishing a contact state between the movable electrode 111A and the fixed electrode 111B, and along with this, enters the open state by establishing a separate state between the movable electrode 111A and the fixed electrode 111B.

The vacuum circuit breaker movable current-carrying shaft 214 is slidably supported by a sliding part SL214. The sliding part SL214 is formed of a metal material and is electrically connected to the gas circuit breaker fixed electrode 101B via an electric wire EC2a. The electric wire EC2a constitutes the interrupting electric circuit EC2 (see FIG. 1).

A bellows 215 and an arc shield 218 are further housed inside the vacuum vessel 212.

The bellows 215 has a cylindrical tubular shape, and has the vacuum circuit breaker movable current-carrying shaft 214 passing therethrough. The internal space of the bellows 215 communicates with the internal space of the grounded tank 200. The bellows 215 is configured to expand and contract in the direction of movement when the movable electrode 111A moves with the sliding of the vacuum circuit breaker movable current-carrying shaft 214.

The arc shield 218 is installed so as to surround the movable electrode 111A and the fixed electrode 111B in the circumferential direction.

### [B-4] Vacuum Circuit Breaker 221

Similarly to the vacuum circuit breaker 211, the vacuum circuit breaker 221 is a vacuum valve, and houses a movable electrode 121A (a second movable electrode) and a fixed electrode 121B (a second fixed electrode) as the second interrupting contact 112 inside a vacuum vessel 222. The vacuum circuit breaker 221 is configured so that the second interrupting contact 112 switches between the closed state and the open state inside the vacuum vessel 222.

Here, the vacuum vessel 222 includes an insulating tube 222a and a pair of flanges 222b, and for example, the flanges 222b in a pair are installed at both ends of the cylindrical tubular insulating tube 222a respectively. The inside of the vacuum vessel 222 is in a vacuum state, where the pressure inside the vacuum vessel 222 is lower than that inside the grounded tank 200.

The movable electrode 121A and the fixed electrode 121B are formed of a metal material and are installed so as to have their ends face each other inside the vacuum vessel 222. Here, the movable electrode 121A is installed at an end of a vacuum circuit breaker movable current-carrying shaft 224 (a second vacuum circuit breaker movable current-carrying shaft). Then, the fixed electrode 121B is installed at an end of a vacuum circuit breaker fixed current-carrying shaft 223 (a second vacuum circuit breaker fixed current-carrying shaft). The vacuum circuit breaker fixed current-carrying shaft 223 is installed so as to be aligned coaxially with the vacuum circuit breaker movable current-carrying shaft 224. Here, the vacuum circuit breaker fixed current-carrying shaft 223 is configured integrally with the vacuum circuit breaker fixed current-carrying shaft 213 and is supported by the support SP.

Further, the vacuum circuit breaker movable current-carrying shaft 224 is connected to an operating mechanism 227 via an insulating rod 226. The vacuum circuit breaker 221 enters, by the operation of the operating mechanism 227, the closed state by establishing a contact state between the movable electrode 121A and the fixed electrode 121B, and along with this, enters the open state by establishing a separate state between the movable electrode 121A and the fixed electrode 121B.

The vacuum circuit breaker movable current-carrying shaft 224 is slidably supported by a sliding part SL224. The sliding part SL224 is formed of a metal material and is electrically connected to the gas circuit breaker movable electrode 101A via an electric wire EC2b. The electric wire EC2b constitutes the interrupting electric circuit EC2 (see FIG. 1).

A bellows 225 and an arc shield 228 are further housed inside the vacuum vessel 222.

The bellows 225 has a cylindrical tubular shape and has the vacuum circuit breaker movable current-carrying shaft 224 passing therethrough. The internal space of the bellows 225 communicates with the internal space of the grounded tank 200. The bellows 225 is configured to expand and contract in the direction of movement when the movable electrode 121A moves with the sliding of the vacuum circuit breaker movable current-carrying shaft 224.

The arc shield 228 is installed so as to surround the movable electrode 121A and the fixed electrode 121B in the circumferential direction.

### [C] Operation of the Circuit Breaker Device 100

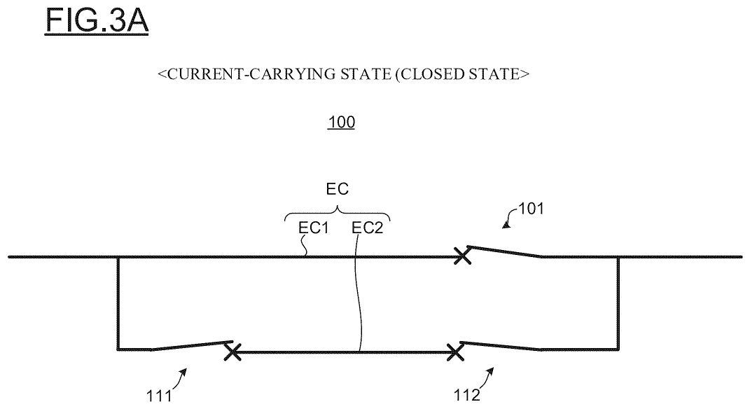

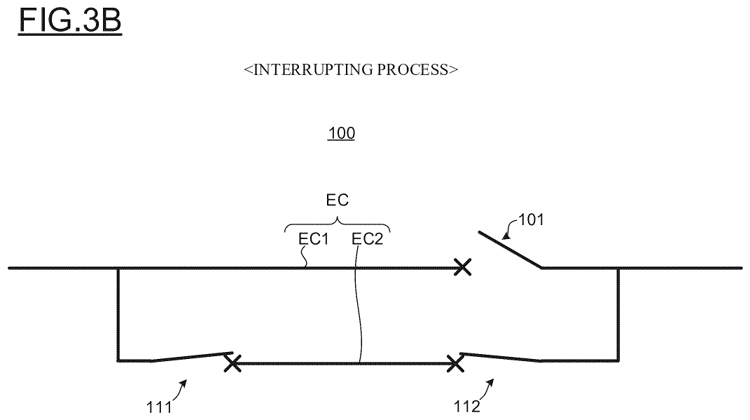

FIG. 3A and FIG. 3B are circuit diagrams each illustrating the operation of the circuit breaker device 100 according to the first embodiment.

In the interrupting operation in this embodiment, the device transitions from the current-carrying state (a closed state, an energized state) illustrated in FIG. 3A, through the interrupting process (an opening process) illustrated in FIG. 3B, to the interrupted state (a fully open state) illustrated in FIG. 1, and thereby the flow of current through the electric circuit EC is interrupted. The interrupting operation is performed, for example, by the operating mechanism 207, the operating mechanism 217, and the operating mechanism 227 operating based on a control command output from a control device (not illustrated).

### [C-1] Current-Carrying State

First, in the current-carrying state, as illustrated in FIG. 3A, the current-carrying contact 101, the first interrupting contact 111, and the second interrupting contact 112 are in the closed state.

Specifically, in the current-carrying state, in the gas circuit breaker 201, the closed state is established between the gas circuit breaker movable electrode 101A and the gas circuit breaker fixed electrode 101B, which are housed as the current-carrying contact 101 inside the insulating gas vessel 202. Further, in the vacuum circuit breaker 211, the closed state is established between the movable electrode 111A and the fixed electrode 111B, which are housed as the first interrupting contact 111 inside the vacuum vessel 212. Further, in the vacuum circuit breaker 221, the closed state is established between the movable electrode 121A and the fixed electrode 121B, which are housed as the second interrupting contact 112 inside the vacuum vessel 222 (see FIG. 2).

As described above, the current-carrying contact 101 is configured to have a resistance smaller than that of the first interrupting contact 111 and the second interrupting contact 112. Therefore, in the current-carrying state, a larger current flows through the current-carrying electric circuit EC1, where the current-carrying contact 101 is installed, than through the interrupting electric circuit EC2, where the first interrupting contact 111 and the second interrupting contact 112 are installed.

### [C-2] Interrupting Process

Next, in the interrupting process of transitioning from the current-carrying state to the interrupted state, as illustrated in FIG. 3B, the current-carrying contact 101 switches from the closed state to the open state.

Specifically, in the interrupting process, in the gas circuit breaker 201, the state between the gas circuit breaker movable electrode 101A and the gas circuit breaker fixed electrode 101B, which are housed as the current-carrying contact 101 inside the insulating gas vessel 202, switches to the open state (see FIG. 2).

Thereby, a fault current flowing through the current-carrying electric circuit EC1, where the current-carrying contact 101 is installed, is commutated to flow through the interrupting electric circuit EC2, where the first interrupting contact 111 and the second interrupting contact 112 are installed.

### [C-3] Interrupted State

Next, in the interrupted state, as illustrated in FIG. 1, the first interrupting contact 111 and the second interrupting contact 112 switch from the closed state to the open state. The first interrupting contact 111 and the second interrupting contact 112 switch from the closed state to the open state simultaneously, for example.

Specifically, in the vacuum circuit breaker 211, the state between the movable electrode 111A and the fixed electrode 111B, which are housed as the first interrupting contact 111 inside the vacuum vessel 212, switches to the open state. Further, in the vacuum circuit breaker 221, the state between the movable electrode 121A and the fixed electrode 121B, which are housed as the second interrupting contact 112 inside the vacuum vessel 222, switches to the open state (see FIG. 2).

Thereby, the flow of the fault current is interrupted in each of the current-carrying electric circuit EC1 and the interrupting electric circuit EC2, and the interrupting operation is completed.

### [D] Summary

As described above, the circuit breaker device 100 in this embodiment is a device that switches the electric circuit EC from the current-carrying state (see FIG. 3A) to the interrupted state (see FIG. 1), and includes the current-carrying contact 101, the first interrupting contact 111, and the second interrupting contact 112. The first interrupting contact 111 is connected in parallel with the current-carrying contact 101. The second interrupting contact 112 is connected in parallel with the current-carrying contact 101 and is also connected in series with the first interrupting contact 111.

In this embodiment, the resistance of the current-carrying contact 101 is smaller than that of the first interrupting contact 111 and that of the second interrupting contact 112. Therefore, in the current-carrying state (see FIG. 3A), the current-carrying contact 101, the first interrupting contact 111, and the second interrupting contact 112 are in the closed state, and a larger current flows through the current-carrying contact 101 than through the first interrupting contact 111 and the second interrupting contact 112. Then, in the interrupting process (see FIG. 3B) of transitioning from the current-carrying state to the interrupted state, the current-carrying contact 101 switches from the closed state to the open state. Thereafter, in the interrupted state (see FIG. 2), the first interrupting contact 111 and the second interrupting contact 112 switch from the closed state to the open state.

In the circuit breaker device 100 in this embodiment, the current-carrying contact 101 is constituted by the gas circuit breaker 201 in which the closed state and the open state are switched inside the insulating gas vessel 202 filled with the insulating gas. The first interrupting contact 111 is constituted by the vacuum circuit breaker 211 in which the closed state and the open state are switched inside the vacuum vessel 212. The second interrupting contact 112 is constituted by the vacuum circuit breaker 221 in which the closed state and the open state are switched inside the vacuum vessel 222 (see FIG. 2).

As described above, in this embodiment, the function of achieving the current-carrying state (see FIG. 3A) is mainly implemented by the current-carrying contact 101 constituted by the gas circuit breaker 201. In contrast, in this embodiment, the function of transitioning from the current-carrying state, through the interrupting process (see FIG. 3B), to the interrupted state finally is implemented by the first interrupting contact 111 constituted by the vacuum circuit breaker 211 and the second interrupting contact 112 constituted by the vacuum circuit breaker 221.

In the circuit breaker device 100 in this embodiment, since the current-carrying contact 101 is constituted by the gas circuit breaker 201, sufficient current-carrying performance can be obtained in the current-carrying state (see FIG. 3A). Therefore, the vacuum circuit breaker 211 constituting the first interrupting contact 111 and the vacuum circuit breaker 221 constituting the second interrupting contact 112 do not need to improve the current-carrying performance, which makes it possible to achieve a reduction in weight and switch from the closed state to the open state at a higher speed. Further, since a plurality of vacuum circuit breakers (the vacuum circuit breaker 211 and the vacuum circuit breaker 221) are connected in series, sufficient dielectric withstand capability can be obtained.

Further, the circuit breaker device 100 in this embodiment enters the interrupted state finally by the first interrupting contact 111 and the second interrupting contact 112, which are constituted by the vacuum circuit breakers (the vacuum circuit breaker 211 and the vacuum circuit breaker 221). Therefore, in the gas circuit breaker 201 constituting the current-carrying contact 101, it is possible to achieve a reduction in the amount of SF₆ gas used, which has high performances such as insulation performance and arc-extinguishing performance, and also to apply a gas having a global warming potential lower than that of the SF₆ gas as the insulating gas. Furthermore, depending on the required current-carrying performance, the gas circuit breaker 201 can be replaced with an air-blast circuit breaker or the like.

Therefore, the circuit breaker device 100 in this embodiment can reduce the use of insulating gas (such as SF₆ gas) having a high global warming potential. Along with this, the circuit breaker device 100 in this embodiment has sufficient dielectric withstand capability and current-carrying performance, even when using the vacuum circuit breakers (the vacuum circuit breaker 211 and the vacuum circuit breaker 221), and can therefore be applied to an electric circuit to which a higher voltage is applied (a power transmission class electric circuit).

### Second Embodiment

### [A] Configuration of a Circuit Breaker Device 100

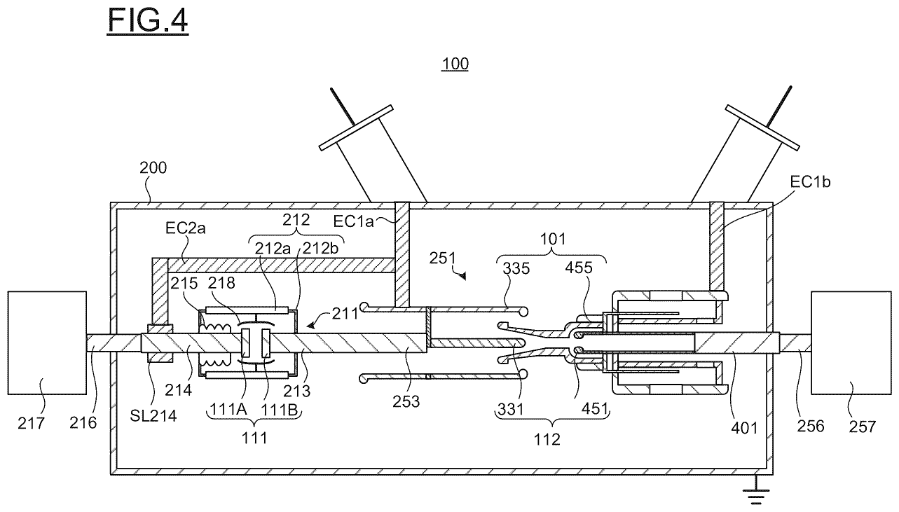

FIG. 4 is a cross-sectional view schematically illustrating a configuration of a circuit breaker device 100 according to a second embodiment. FIG. 4 illustrates the state where the circuit breaker device 100 is in the interrupted state.

As illustrated in FIG. 4, the circuit breaker device 100 in this embodiment houses, inside the grounded tank 200, a gas circuit breaker 251 in place of the gas circuit breaker 201 and the vacuum circuit breaker 221, in addition to the vacuum circuit breaker 211, which is different from the case of the first embodiment (see FIG. 2). Except for this point and related matters, the circuit breaker device 100 in this embodiment is the same as the case of the first embodiment (see FIG. 2). Therefore, explanations of overlapping matters will be omitted as appropriate.

As illustrated in FIG. 4, in the circuit breaker device 100 in this embodiment, the first interrupting contact 111 is constituted by the vacuum circuit breaker 211. However, in this embodiment, the current-carrying contact 101 and the second interrupting contact 112 are constituted by the gas circuit breaker 251 in which the closed state and the open state are switched inside the grounded tank 200. The grounded tank 200 is filled with, for example, a gas having a global warming potential lower than that of the SF₆ gas as an insulating gas.

As illustrated in FIG. 4, the gas circuit breaker 251 includes a gas circuit breaker movable current-carrying shaft 401 and a gas circuit breaker fixed current-carrying shaft 253. A driving-side arc contact 451 and a driving-side current-carrying contact 455 are provided on the gas circuit breaker movable current-carrying shaft 401. The gas circuit breaker fixed current-carrying shaft 253 is aligned coaxially with the gas circuit breaker movable current-carrying shaft 401, on which an opposite-side arc contact 331 and an opposite-side current-carrying contact 335 are provided. The gas circuit breaker fixed current-carrying shaft 253 is configured integrally with the vacuum circuit breaker fixed current-carrying shaft 213 and is supported by the support SP.

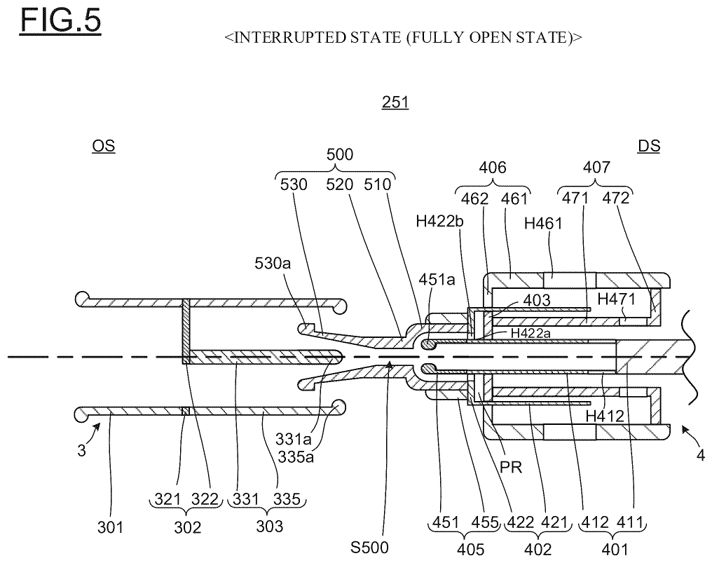

FIG. 5 is a cross-sectional view illustrating the detailed configuration of the gas circuit breaker 251 in the circuit breaker device 100 according to the second embodiment.

Hereinafter, the detailed configuration of the gas circuit breaker 251 will be explained using FIG. 5 in addition to FIG. 4.

The gas circuit breaker 251 is a puffer type and includes an opposite-side unit 3 and a driving-side unit 4, as illustrated in FIG. 5.

### [A-1] Opposite-Side Unit 3

In the gas circuit breaker 251, the opposite-side unit 3 includes a cooling cylinder 301, a support part 302, and an opposite-side contact part 303. The cooling cylinder 301, the support part 302, and the opposite-side contact part 303 are each formed of, for example, a metal material and are each electrically connected to the electric wire EC1a.

### [A-1-1] Cooling Cylinder 301

The cooling cylinder 301 is, for example, a cylindrical tubular body and is connected to the electric wire EC1a. The cooling cylinder 301 is supported by the grounded tank 200 via the support SP (see FIG. 4).

### [A-1-2] Support Part 302

The support part 302 includes a support ring portion 321 and a support protrusion 322.

The support ring portion 321 is, for example, an annular ring-shaped body and is installed coaxially with the cooling cylinder 301 on the end surface of the cooling cylinder 301 located on a driving side DS. Here, the outer diameter of the support ring portion 321 is, for example, the same as that of the cooling cylinder 301, and the inner diameter of the support ring portion 321 is, for example, the same as that of the cooling cylinder 301.

The support protrusion 322 is, for example, a bar-shaped body and is provided so as to project radially inward on the inner circumferential surface of the support ring portion 321. In the support part 302, the support ring portion 321 is formed using a conductive material such as metal. In contrast, the support protrusion 322 is formed using an insulating material to establish an electrically insulating state between the opposite-side arc contact 331 and the opposite-side current-carrying contact 335 by the support protrusion 322. However, the support protrusion 322 is partially formed using a conductive material so as to electrically connect the gas circuit breaker fixed current-carrying shaft 253 and the opposite-side arc contact 331 (see FIG. 4).

### [A-1-3] Opposite-Side Contact Part 303

The opposite-side contact part 303 includes the opposite-side arc contact 331 and the opposite-side current-carrying contact 335, and is provided inside the grounded tank 200.

### [A-1-3-1] Opposite-Side Arc Contact 331

The opposite-side arc contact 331 is, for example, a cylindrical bar-shaped body and extends in the axial direction. The opposite-side arc contact 331 is installed coaxially with the cooling cylinder 301 and the like on the surface of the support protrusion 322 located on the driving side DS. An end 331a of the opposite-side arc contact 331 located on the driving side DS is curved.

### [A-1-3-2] Opposite-Side Current-Carrying Contact 335

The opposite-side current-carrying contact 335 is, for example, a cylindrical tubular body and is installed coaxially with the opposite-side arc contact 331 and the like via the support part 302 on the end surface of the cooling cylinder 301 located on the driving side DS. The opposite-side current-carrying contact 335 includes a portion that houses the opposite-side arc contact 331 thereinside.

Here, the outer diameter of the opposite-side current-carrying contact 335 is, for example, the same as that of the cooling cylinder 301, and the inner diameter of the opposite-side current-carrying contact 335 includes a portion that is, for example, the same as the inner diameter of the cooling cylinder 301. An end 335a of the opposite-side current-carrying contact 335 located on the driving side DS projects radially inward.

### [A-2] Driving-Side Unit 4

The driving-side unit 4 includes the gas circuit breaker movable current-carrying shaft 401 (movable current-carrying shaft), a puffer cylinder 402, a puffer piston 403, a driving-side contact part 405, a cylinder support 406, a piston support 407, and an insulating nozzle 500. The gas circuit breaker movable current-carrying shaft 401, the puffer cylinder 402, the puffer piston 403, the driving-side contact part 405, the cylinder support 406, and the piston support 407 are each formed of, for example, a metal material and are each electrically connected to the electric wire EC1b.

### [A-2-1] Gas Circuit Breaker Movable Current-Carrying Shaft 401

The gas circuit breaker movable current-carrying shaft 401 is a bar-shaped body and is installed coaxially with the opposite-side arc contact 331 and the like. The gas circuit breaker movable current-carrying shaft 401 is connected to an operating mechanism 257 via an insulating rod 256 and is configured to move in the axial direction by the operating mechanism 257.

Here, the gas circuit breaker movable current-carrying shaft 401 includes a movable current-carrying shaft solid portion 411 and a movable current-carrying shaft hollow portion 412.

The movable current-carrying shaft solid portion 411 has, for example, a cylindrical shape.

The movable current-carrying shaft hollow portion 412 has, for example, a cylindrical tubular shape, and has an end thereof that is located on the driving side DS connected to the movable current-carrying shaft solid portion 411. The outer diameter of the movable current-carrying shaft hollow portion 412 is, for example, the same as that of the movable current-carrying shaft solid portion 411. The inner diameter of the movable current-carrying shaft hollow portion 412 is larger than the outer diameter of the opposite-side arc contact 331. A first ventilation hole H412, which passes through in the radial direction, is formed in the end of the movable current-carrying shaft hollow portion 412 located on the driving side DS.

### [A-2-2] Puffer Cylinder 402

The puffer cylinder 402 is configured to slide in the axial direction together with the gas circuit breaker movable current-carrying shaft 401 by the operating mechanism 257.

Here, the puffer cylinder 402 includes a cylinder cylindrical tubular portion 421 and a cylinder bottom plate portion 422.

The cylinder cylindrical tubular portion 421 is, for example, a cylindrical tubular body and is installed coaxially with the opposite-side arc contact 331 and the like. The inner diameter of the cylinder cylindrical tubular portion 421 is larger than the outer diameter of the gas circuit breaker movable current-carrying shaft 401, and the gas circuit breaker movable current-carrying shaft 401 is housed inside the cylinder cylindrical tubular portion 421.

The cylinder bottom plate portion 422 is, for example, a disk-shaped plate body and is provided at the end of the cylinder cylindrical tubular portion 421 located on the driving side DS.

A rod through hole H422a through which the gas circuit breaker movable current-carrying shaft 401 passes is formed in the center of the cylinder bottom plate portion 422. The inner diameter of the rod through hole H422a is substantially the same as the outer diameter of the gas circuit breaker movable current-carrying shaft 401, and the gas circuit breaker movable current-carrying shaft 401 is fixed to the puffer cylinder 402 with the gas circuit breaker movable current-carrying shaft 401 passing through the rod through hole H422a. The cylinder bottom plate portion 422 and the gas circuit breaker movable current-carrying shaft 401 are electrically connected.

Further, an exhaust hole H422b is formed in the cylinder bottom plate portion 422. The exhaust hole H422b is formed so as to pass through in the axial direction around the rod through hole H422a. Here, the exhaust hole H422b is configured to communicate with the rod through hole H422a, for example.

### [A-2-3] Puffer Piston 403

The puffer piston 403 is housed inside the puffer cylinder 402. The puffer piston 403 is fixed to the grounded tank 200 via the cylinder support 406 and the piston support 407. The puffer piston 403 is, for example, an annular ring-shaped body and is installed coaxially with the opposite-side arc contact 331 and the like. The gas circuit breaker movable current-carrying shaft 401 passes through the inside of the puffer piston 403.

Here, the inner diameter of the puffer piston 403 is substantially the same as the outer diameter of the gas circuit breaker movable current-carrying shaft 401, and the gas circuit breaker movable current-carrying shaft 401 is slidable in the axial direction relative to the puffer piston 403. Further, the outer diameter of the puffer piston 403 is substantially the same as the inner diameter of the cylinder cylindrical tubular portion 421 constituting the puffer cylinder 402, and the puffer cylinder 402 is slidable in the axial direction relative to the puffer piston 403.

The puffer piston 403 partitions the inside of the puffer cylinder 402 in the axial direction. The space inside the puffer cylinder 402 located on the driving side DS relative to the puffer piston 403 is a puffer chamber PR. The volume of the puffer chamber PR varies as the puffer cylinder 402 moves in the axial direction together with the gas circuit breaker movable current-carrying shaft 401. As the volume of the puffer chamber PR decreases, the pressure of the insulating gas increases inside the puffer chamber PR. Then, although details will be described later, the insulating gas whose pressure has increased in the puffer chamber PR is discharged from the puffer chamber PR through the exhaust hole H422b of the puffer cylinder 402.

### [A-2-4] Driving-Side Contact Part 405

The driving-side contact part 405 is configured to slide in the axial direction together with the gas circuit breaker movable current-carrying shaft 401 by the operating mechanism 257, thereby varying the distance between the driving-side contact part 405 and the opposite-side contact part 303.

Here, the driving-side contact part 405 includes the driving-side arc contact 451 and the driving-side current-carrying contact 455.

### [A-2-4-1] Driving-Side Arc Contact 451

The driving-side arc contact 451 is, for example, a cylindrical tubular body and is installed coaxially with the opposite-side arc contact 331 and the like.

Here, the driving-side arc contact 451 has substantially the same outer diameter and inner diameter as the movable current-carrying shaft hollow portion 412 constituting the gas circuit breaker movable current-carrying shaft 401. The driving-side arc contact 451 is connected to the end of the movable current-carrying shaft hollow portion 412 located on an opposite side OS and is electrically connected to the gas circuit breaker movable current-carrying shaft 401. The driving-side arc contact 451 is configured to slide in the axial direction together with the gas circuit breaker movable current-carrying shaft 401 by the operating mechanism 257.

An end 451a of the driving-side arc contact 451 located on the opposite side OS projects radially inward, and the inner diameter of the end 451a is the same as the outer diameter of the opposite-side arc contact 331.

Although details will be described later, the driving-side arc contact 451 is configured so that the opposite-side arc contact 331 is inserted thereinside in the current-carrying state, and arc discharge occurs between the driving-side arc contact 451 and the opposite-side arc contact 331 during the interrupting process.

### [A-2-4-2] Driving-Side Current-Carrying Contact 455

The driving-side current-carrying contact 455 is, for example, an annular ring-shaped body and is installed coaxially with the opposite-side arc contact 331 and the like. The driving-side current-carrying contact 455 includes a portion that houses the driving-side arc contact 451 thereinside.

Here, the inner diameter of the driving-side current-carrying contact 455 is larger than the outer diameter of the driving-side arc contact 451. The outer diameter of the driving-side current-carrying contact 455 is the same as the inner diameter of the end 335a of the opposite-side current-carrying contact 335. The driving-side current-carrying contact 455 is fixed to the cylinder bottom plate portion 422 of the puffer cylinder 402 so as to surround the driving-side arc contact 451 and is electrically connected to the puffer cylinder 402. The driving-side current-carrying contact 455 is configured to slide in the axial direction together with the gas circuit breaker movable current-carrying shaft 401 by the operating mechanism 257.

An end 455a of the driving-side current-carrying contact 455 located on the opposite side OS is, for example, curved.

Although details will be described later, the driving-side current-carrying contact 455 is configured to be inserted inside the opposite-side current-carrying contact 335 in the current-carrying state.

### [A-2-5] Cylinder Support 406

The cylinder support 406 is electrically connected to the puffer cylinder 402 and the electric wire EC1b. The cylinder support 406 is fixed to the grounded tank 200 and supports the puffer cylinder 402 so that the puffer cylinder 402 slides in the axial direction.

Here, the cylinder support 406 includes a cylinder support cylindrical tubular portion 461 and a cylinder support ring portion 462.

The cylinder support cylindrical tubular portion 461 is a cylindrical tubular body and is installed coaxially with the opposite-side arc contact 331 and the like. The inner diameter of the cylinder support cylindrical tubular portion 461 is larger than the outer diameter of the cylinder cylindrical tubular portion 421 constituting the puffer cylinder 402.

The cylinder support ring portion 462 is an annular ring-shaped body and is installed coaxially with the opposite-side arc contact 331 and the like. The cylinder support ring portion 462 is provided at the end of the cylinder support cylindrical tubular portion 461 located on the opposite side OS and is configured to project radially inward from the cylinder support cylindrical tubular portion 461. Here, the cylinder support ring portion 462 is formed integrally with the cylinder support cylindrical tubular portion 461. The inner diameter of the cylinder support ring portion 462 is the same as the outer diameter of the cylinder support cylindrical tubular portion 421 constituting the puffer cylinder 402.

A second ventilation hole H461 is formed in the cylinder support cylindrical tubular portion 461. The second ventilation hole H461 is configured to pass through the cylinder support cylindrical tubular portion 461 in the radial direction.

### [A-2-6] Piston Support 407

The piston support 407 is fixed to the cylinder support 406 and supports the puffer piston 403. The gas circuit breaker movable current-carrying shaft 401 passes through the inside of the piston support 407.

Here, the piston support 407 includes a piston support cylindrical tubular portion 471 and a piston support ring portion 472.

The piston support cylindrical tubular portion 471 is a cylindrical tubular body and is installed coaxially with the opposite-side arc contact 331 and the like. The outer diameter of the piston support cylindrical tubular portion 471 is smaller than that of the puffer piston 403, and the inner diameter of the piston support cylindrical tubular portion 471 is larger than the outer diameter of the gas circuit breaker movable current-carrying shaft 401. The end of the piston support cylindrical tubular portion 471 located on the opposite side OS is connected to the puffer piston 403.

The piston support ring portion 472 is an annular ring-shaped body and is installed coaxially with the opposite-side arc contact 331 and the like. The piston support ring portion 472 is provided at the end of the piston support cylindrical tubular portion 471 located on the driving side DS. The outer diameter of the piston support ring portion 472 is smaller than that of the piston support cylindrical tubular portion 471, and the inner diameter of the piston support ring portion 472 is larger than the outer diameter of the gas circuit breaker movable current-carrying shaft 401. The outer diameter of the piston support ring portion 472 is the same as the inner diameter of the cylinder support cylindrical tubular portion 461, and the piston support ring portion 472 is fixed to the cylinder support cylindrical tubular portion 461. Here, the piston support ring portion 472 is formed integrally with the cylinder support cylindrical tubular portion 471.

A third ventilation hole H471 is formed in the piston support cylindrical tubular portion 471. The third ventilation hole H471 is configured to pass through the piston support cylindrical tubular portion 471 in the radial direction.

### [A-2-7] Insulating Nozzle 500

The insulating nozzle 500 is formed of an insulating material. The insulating nozzle 500 is a cylindrical tubular body and is installed coaxially with the opposite-side arc contact 331 and the like inside the grounded tank 200.

The insulating nozzle 500 is fixed to the puffer cylinder 402 and is configured to move together with the puffer cylinder 402, the driving-side contact part 405, and the like, during the interrupting process of transitioning from the current-carrying state to the open state.

A nozzle internal space S500 is formed inside the insulating nozzle 500, and the opposite-side arc contact 331 and the driving-side arc contact 451 are housed in the nozzle internal space S500. Further, the insulating nozzle 500 is configured so that the insulating gas is discharged from the puffer chamber PR into the nozzle internal space S500 when arc discharge occurs between the opposite-side contact part 303 and the driving-side contact part 405 during the interrupting process.

The insulating nozzle 500 includes a nozzle large diameter portion 510, a nozzle small diameter portion 520, and a nozzle inclined portion 530.

The nozzle large diameter portion 510 is a portion of the insulating nozzle 500 located on the driving side DS and is interposed between the driving-side arc contact 451 and the driving-side current-carrying contact 455. The nozzle large diameter portion 510 includes a portion whose outer circumferential surface extends along the axial direction.

The nozzle small diameter portion 520 is located on the opposite side OS relative to the nozzle large diameter portion 510 in the insulating nozzle 500. The nozzle small diameter portion 520 includes a portion whose outer circumferential surface extends along the axial direction. The outer diameter of the portion whose outer circumferential surface extends along the axial direction in the nozzle small diameter portion 520 is smaller than that of the nozzle large diameter portion 510.

The nozzle inclined portion 530 is located on the opposite side OS relative to the nozzle small diameter portion 520 in the insulating nozzle 500. The nozzle inclined portion 530 includes a portion whose outer circumferential surface is inclined relative to the axial direction, such that the outer diameter increases as it moves from the nozzle small diameter portion 520 toward the opposite side OS. An end 530a of the nozzle inclined portion 530 located on the opposite side OS projects radially outward, and the outer diameter of the end 530a is smaller than the inner diameter of the opposite-side current-carrying contact 335.

### [B] Operation of the Circuit Breaker Device 100

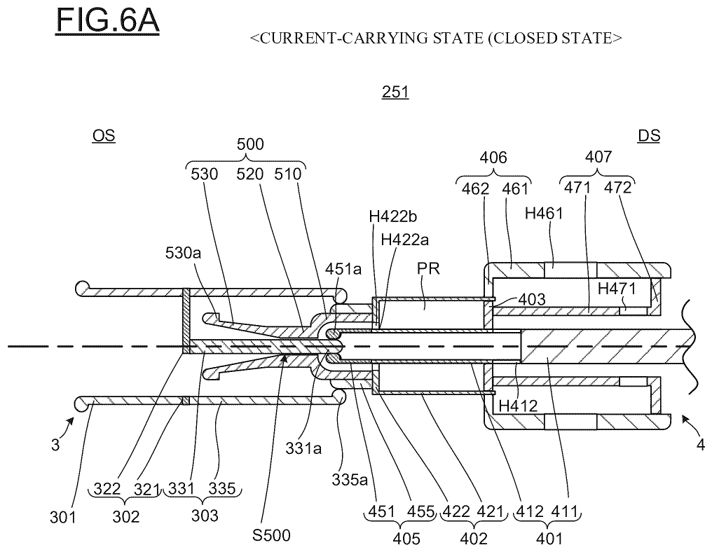

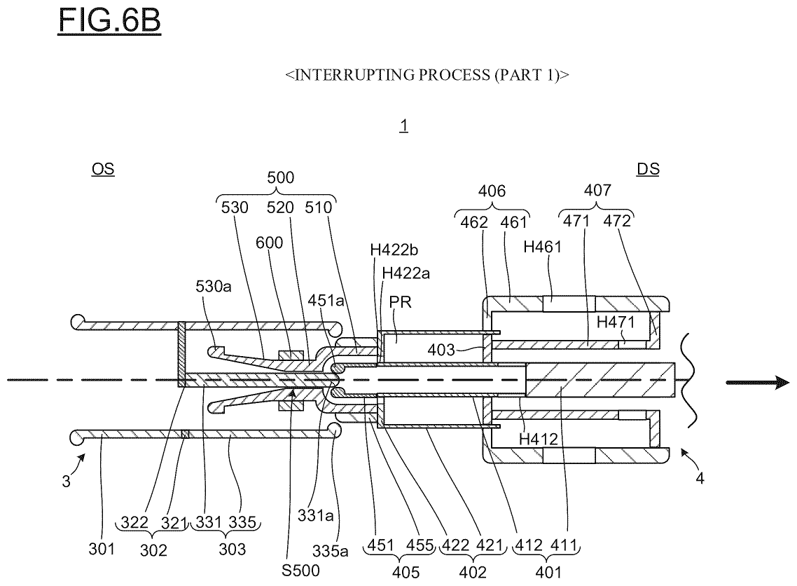

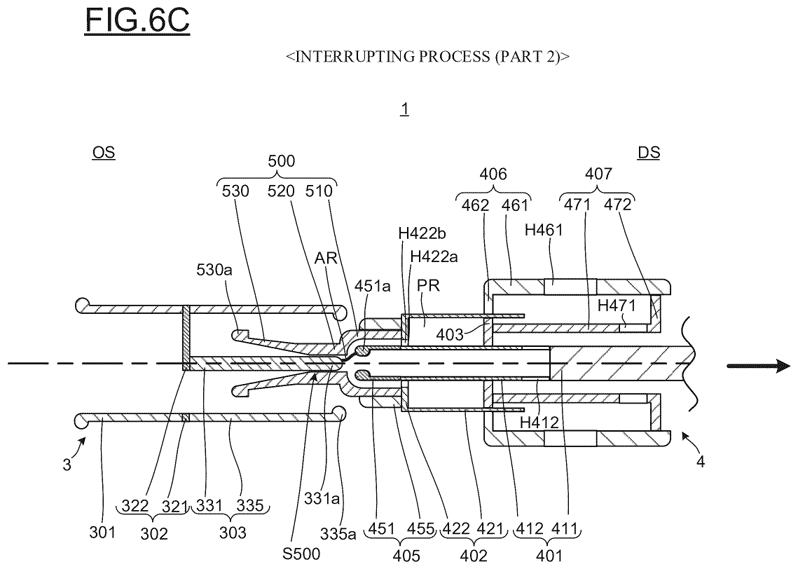

FIG. 6A, FIG. 6B, and FIG. 6C are views illustrating the operation of the gas circuit breaker 251 in the circuit breaker device 100 according to the second embodiment.

In the interrupting operation in this embodiment, the device transitions from the current-carrying state (closed state, energized state) illustrated in FIG. 6A, through the interrupting process (opening process) sequentially illustrated in FIG. 6B and FIG. 6C, to the interrupted state (fully open state) illustrated in FIG. 5, and thereby the flow of current through the electric circuit EC is interrupted. The interrupting operation is performed, for example, by the operating mechanism 217 and the operating mechanism 257 operating based on a control command output from the control device (not illustrated).

Hereinafter, the interrupting operation in this embodiment will be explained using FIG. 4, FIG. 6A, FIG. 6B, FIG. 6C, and FIG. 5, together with FIG. 3A, FIG. 3B, and FIG. 1 used in the first embodiment.

### [B-1] Current-Carrying State

First, in the current-carrying state, as illustrated in FIG. 3A, the current-carrying contact 101, the first interrupting contact 111, and the second interrupting contact 112 are in the closed state.

Specifically, in the current-carrying state, in the gas circuit breaker 251, the contact state is established between the driving-side current-carrying contact 455 and the opposite-side current-carrying contact 335, which constitute the current-carrying contact 101, and thereby it is in the closed state. Further, in the gas circuit breaker 251, the contact state is established between the driving-side arc contact 451 and the opposite-side arc contact 331, which constitute the second interrupting contact 112, and thereby it is in the closed state (see FIG. 6A). Although not illustrated, in the vacuum circuit breaker 211, the closed state is established also between the movable electrode 111A and the fixed electrode 111B, which constitute the first interrupting contact 111 (see FIG. 4).

In this embodiment as well, similarly to the first embodiment, the current-carrying contact 101 is configured to have a resistance smaller than that of the first interrupting contact 111 and the second interrupting contact 112. Therefore, in the current-carrying state, a larger current flows through the current-carrying electric circuit EC1, where the current-carrying contact 101 is installed, than through the interrupting electric circuit EC2, where the first interrupting contact 111 and the second interrupting contact 112 are installed (see FIG. 3A).

### [B-2] Interrupting Process

Next, in the interrupting process of transitioning from the current-carrying state to the interrupted state, as illustrated in FIG. 3B, the current-carrying contact 101 switches from the closed state to the open state.

Here, in the gas circuit breaker 251, the separate state is established between the driving-side current-carrying contact 455 and the opposite-side current-carrying contact 335, which constitute the current-carrying contact 101, and thereby it switches to the open state (see FIG. 6B).

Specifically, in the driving-side unit 4 constituting the gas circuit breaker 251, the gas circuit breaker movable current-carrying shaft 401 moves toward the driving side DS in the axial direction. As the gas circuit breaker movable current-carrying shaft 401 moves, the puffer cylinder 402, the driving-side contact part 405, and the insulating nozzle 500 move toward the driving side DS in the axial direction in the driving-side unit 4. Thereby, the opposite-side current-carrying contact 335 and the driving-side current-carrying contact 455 enter the separate state from the contact state while maintaining the contact state between the opposite-side arc contact 331 and the driving-side arc contact 451.

As a result, similarly to the case of the first embodiment, the fault current flowing through the current-carrying electric circuit EC1, where the current-carrying contact 101 is installed, is commutated to flow through the interrupting electric circuit EC2, where the first interrupting contact 111 and the second interrupting contact 112 are installed.

### [B-3] Interrupted State

Next, in the interrupted state, as illustrated in FIG. 1, the first interrupting contact 111 and the second interrupting contact 112 switch from the closed state to the open state. The first interrupting contact 111 and the second interrupting contact 112 switch from the closed state to the open state simultaneously, for example.

Here, in the vacuum circuit breaker 211, the state between the movable electrode 111A and the fixed electrode 111B, which constitute the first interrupting contact 111, switches to the open state (see FIG. 4).

Further, in the gas circuit breaker 251, the separate state is established between the driving-side arc contact 451 and the opposite-side arc contact 331, which constitute the second interrupting contact 112, and thereby it switches to the open state (see FIG. 6C, FIG. 5).

Specifically, as illustrated in FIG. 6C, in the gas circuit breaker 251, as the gas circuit breaker movable current-carrying shaft 401 moves further toward the driving side DS, the opposite-side arc contact 331 moves from the inside of the driving-side arc contact 451 to the outside, resulting in that the opposite-side arc contact 331 and the driving-side arc contact 451 enter the separate state from the contact state.

At this time, arc discharge AR occurs between the opposite-side arc contact 331 and the driving-side arc contact 451 inside the insulating nozzle 500. The insulating gas is heated by the arc discharge AR to expand inside the insulating nozzle 500, and thereby the insulating gas flows from the inside of the insulating nozzle 500 into the puffer chamber PR. Further, with the movement of the gas circuit breaker movable current-carrying shaft 401, the puffer cylinder 402 slides relative to the puffer piston 403, resulting in that the volume of the puffer chamber PR decreases. Thereby, the pressure of the insulating gas increases in the puffer chamber PR.

Then, as the distance between the opposite-side arc contact 331 and the driving-side arc contact 451 further increases, the arc discharge AR decreases. When the arc discharge AR decreases and the pressure of the insulating gas in the puffer chamber PR further increases, the flow of the insulating gas from the inside of the insulating nozzle 500 into the puffer chamber PR stops. Thereafter, the high-pressure insulating gas is discharged from the puffer chamber PR into the insulating nozzle 500. The insulating gas discharged from the puffer chamber PR flows between the insulating nozzle 500 and the driving-side arc contact 451 and is blown onto the arc discharge AR. As a result, the arc discharge AR is extinguished at the current zero point.

Then, as illustrated in FIG. 5, as the gas circuit breaker movable current-carrying shaft 401 moves further toward the driving side DS in the axial direction, the most separate state is established between the opposite-side current-carrying contact 335 and the driving-side current-carrying contact 455, and concurrently, the most separate state is established between the opposite-side arc contact 331 and the driving-side arc contact 451.

At this time, the volume of the puffer chamber PR further decreases with the movement of the gas circuit breaker movable current-carrying shaft 401, and the insulating gas is further discharged from the inside of the puffer chamber PR into the insulating nozzle 500. Here, the insulating gas flows sequentially from the inside of the insulating nozzle 500 through the inside of the opposite-side current-carrying contact 335 and the inside of the cooling cylinder 301, and is then discharged from the inside of the cooling cylinder 301 to the outside. In addition, the insulating gas flows sequentially from the inside of the insulating nozzle 500 through the inside of the driving-side arc contact 451, the inside of the movable current-carrying shaft hollow portion 412, and the inside of the piston support cylindrical tubular portion 471, and is then discharged from the inside of the piston support cylindrical tubular portion 471 to the outside. The insulating gas discharged from the piston support cylindrical tubular portion 471 to the outside is discharged from the inside of the cylinder support 406 to the outside.

As above, in this embodiment as well, similarly to the case of the first embodiment, by the first interrupting contact 111 and the second interrupting contact 112 switching from the closed state to the open state, the flow of current is interrupted in each of the current-carrying electric circuit EC1 and the interrupting electric circuit EC2, and the interrupting operation is completed.

### [C] Summary

As described above, in the circuit breaker device 100 in this embodiment, the first interrupting contact 111 is constituted by the vacuum circuit breaker 211, similarly to the case of the first embodiment. In contrast, the current-carrying contact 101 and the second interrupting contact 112 are constituted by the gas circuit breaker 251 in which the closed state and the open state are switched inside the grounded tank 200 filled with the insulating gas, which is different from the case of the first embodiment.

In this embodiment, the function of achieving the current-carrying state (see FIG. 3A) is mainly implemented by the current-carrying contact 101 constituted by the gas circuit breaker 251. In contrast, in this embodiment, the function of transitioning from the current-carrying state, through the interrupting process (see FIG. 3B), to the interrupted state finally is implemented by the first interrupting contact 111 constituted by the vacuum circuit breaker 211 and the second interrupting contact 112 constituted by the gas circuit breaker 251.

In the circuit breaker device 100 in this embodiment as well, similarly to the case of the first embodiment, since the current-carrying contact 101 is constituted by the gas circuit breaker 251, sufficient current-carrying performance can be obtained in the current-carrying state (see FIG. 3A). Therefore, in the circuit breaker device 100 in this embodiment, the vacuum circuit breaker 211 constituting the first interrupting contact 111 does not need to improve the current-carrying performance, which makes it possible to switch from the closed state to the open state at a higher speed and concurrently obtain sufficient dielectric withstand capability.

Further, in the circuit breaker device 100 in this embodiment, the first interrupting contact 111 constituted by the vacuum circuit breaker 211 is used to achieve the interrupted state finally. Therefore, in the gas circuit breaker 251 constituting the current-carrying contact 101 and the second interrupting contact 112, it is possible to achieve a reduction in the amount of SF₆ gas used, which has high performances such as insulation performance and arc-extinguishing performance, and also to apply a gas having a global warming potential lower than that of the SF₆ gas as the insulating gas. Further, depending on the required current-carrying performance, the gas circuit breaker 251 can be replaced with an air-blast circuit breaker or the like.

Therefore, the circuit breaker device 100 in this embodiment can reduce the use of insulating gas (such as SF₆ gas) having a high global warming potential. Along with this, the circuit breaker device 100 in this embodiment has sufficient dielectric withstand capability and current-carrying performance, even when using the vacuum circuit breaker 211, and can therefore be applied to an electric circuit to which a higher voltage is applied (a power transmission class electric circuit).

Incidentally, immediately after the current zero point in the interrupting operation, the vacuum circuit breaker 211 has more excellent dielectric withstand capability than the gas circuit breaker 251. After several milliseconds have passed from the current zero point, the gas circuit breaker 251 has more excellent dielectric withstand capability than the vacuum circuit breaker 211. Therefore, when performing the interrupting operation in this embodiment, excellent dielectric withstand capability is first obtained by the vacuum circuit breaker 211, and thereafter, excellent dielectric withstand capability is obtained by the gas circuit breaker 251.

### Third Embodiment

### [A] Configuration of a Vacuum Circuit Breaker 211

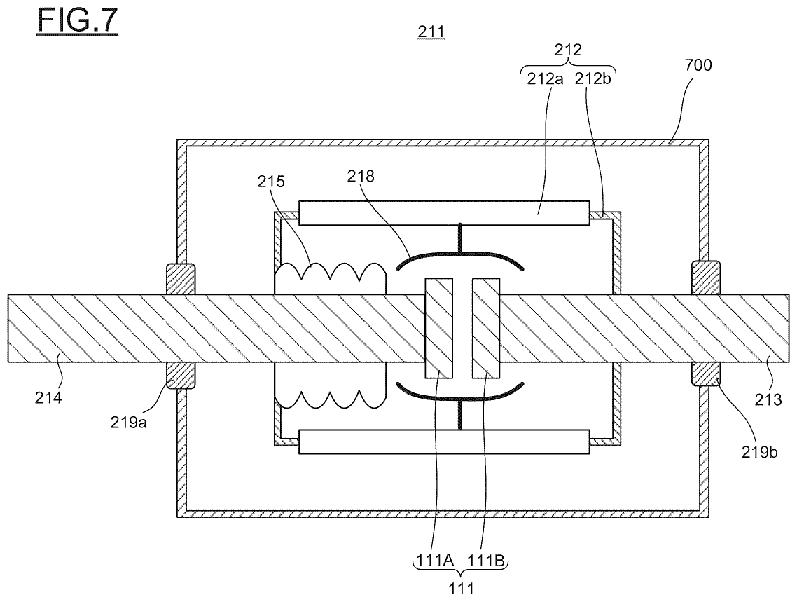

FIG. 7 is a cross-sectional view schematically illustrating a configuration of a vacuum circuit breaker 211 in a circuit breaker device 100 according to a third embodiment.

As illustrated in FIG. 7, the vacuum circuit breaker 211 in this embodiment includes a vacuum circuit breaker housing vessel 700, which is different from the case of the first embodiment (see FIG. 2). Except for this point and related matters, the circuit breaker device 100 in this embodiment is the same as the case of the first embodiment (see FIG. 2). Therefore, explanations of overlapping matters will be omitted as appropriate.

In this embodiment, as illustrated in FIG. 7, the vacuum circuit breaker housing vessel 700 houses the vacuum circuit breaker 211 thereinside, inside the grounded tank 200. The vacuum circuit breaker housing vessel 700 is formed of an insulating material and is installed so as to cover the entire vacuum circuit breaker 211.

Here, the vacuum circuit breaker fixed current-carrying shaft 213 and the vacuum circuit breaker movable current-carrying shaft 214 pass through the vacuum circuit breaker housing vessel 700. A sealing member 219a is interposed between the vacuum circuit breaker housing vessel 700 and the vacuum circuit breaker fixed current-carrying shaft 213, and between the vacuum circuit breaker housing vessel 700 and the vacuum circuit breaker movable current-carrying shaft 214, and thereby the inside of the vacuum circuit breaker housing vessel 700 is sealed.

The pressure inside the vacuum circuit breaker housing vessel 700 is lower than that inside the grounded tank 200 and is higher than that inside the vacuum vessel 212. The internal space of the vacuum circuit breaker housing vessel 700 and the internal space of the bellows 215 constituting the vacuum circuit breaker 211 are in communication with each other.

### [B] Summary

As described above, in this embodiment, the vacuum circuit breaker housing vessel 700 houses the vacuum circuit breaker 211 thereinside, inside the grounded tank 200. As described above, the pressure inside the vacuum circuit breaker housing vessel 700 is lower than that inside the grounded tank 200 and is higher than that inside the vacuum vessel 212. Therefore, in this embodiment, it is possible to effectively prevent occurrence of damage to the bellows 215, even when the movable electrode 111A moves at a high speed and the bellows 215 expands and contracts at a high speed with the sliding of the vacuum circuit breaker movable current-carrying shaft 214.

### [C] Modified Example

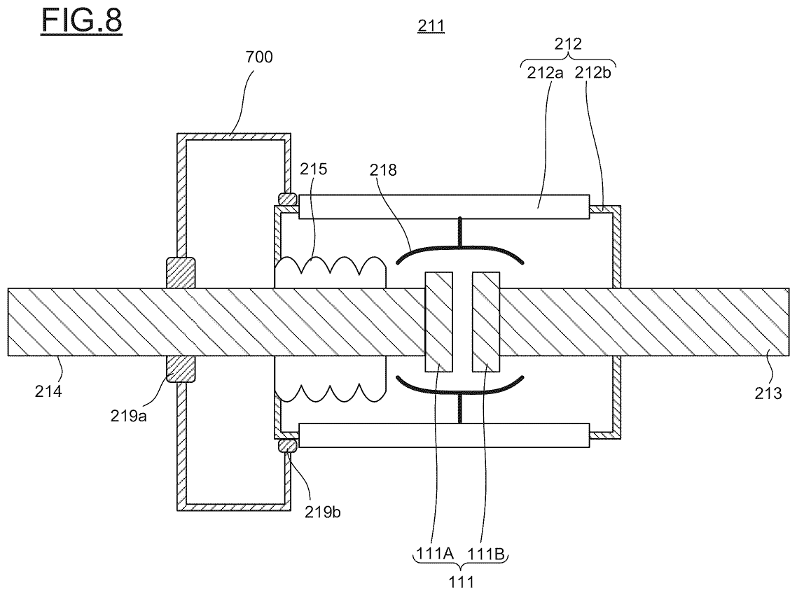

FIG. 8 is a cross-sectional view schematically illustrating a configuration of a vacuum circuit breaker 211 in a circuit breaker device 100 according to a modified example of the third embodiment.

In this modified example, the vacuum circuit breaker housing vessel 700 is installed so as to cover a portion of the vacuum circuit breaker 211, as illustrated in FIG. 8.

Here, the vacuum circuit breaker housing vessel 700 includes a portion through which the vacuum circuit breaker fixed current-carrying shaft 213 passes and a portion through which, of the pair of flanges 212b, the flange 212b on the side where the bellows 215 is installed passes. The sealing member 219a is interposed between the vacuum circuit breaker housing vessel 700 and the vacuum circuit breaker fixed current-carrying shaft 213, and between the vacuum circuit breaker housing vessel 700 and the flange 212b, and thereby the inside of the vacuum circuit breaker housing vessel 700 is sealed. In this modified example, the vacuum circuit breaker housing vessel 700 may be formed of a metal material.

The pressure inside the vacuum circuit breaker housing vessel 700 is lower than that inside the grounded tank 200 and is higher than that inside the vacuum vessel 212. The internal space of the vacuum circuit breaker housing vessel 700 and the internal space of the bellows 215 constituting the vacuum circuit breaker 211 are in communication with each other. Therefore, effects similar to those of the above-described embodiment can be obtained even in this modified example.

Incidentally, in the above-described embodiment, the case where the vacuum circuit breaker housing vessel 700 houses the vacuum circuit breaker 211 in the case of the first embodiment (see FIG. 2) has been explained, but the present invention is not limited to this. In the case of the first embodiment (see FIG. 2), the vacuum circuit breaker housing vessel 700 may be configured to house the vacuum circuit breaker 221. Further, in the case of the second embodiment (see FIG. 4), the vacuum circuit breaker housing vessel 700 may be configured to house the vacuum circuit breaker 211.

### Fourth Embodiment

### [A] Configuration of a Circuit Breaker Device 100

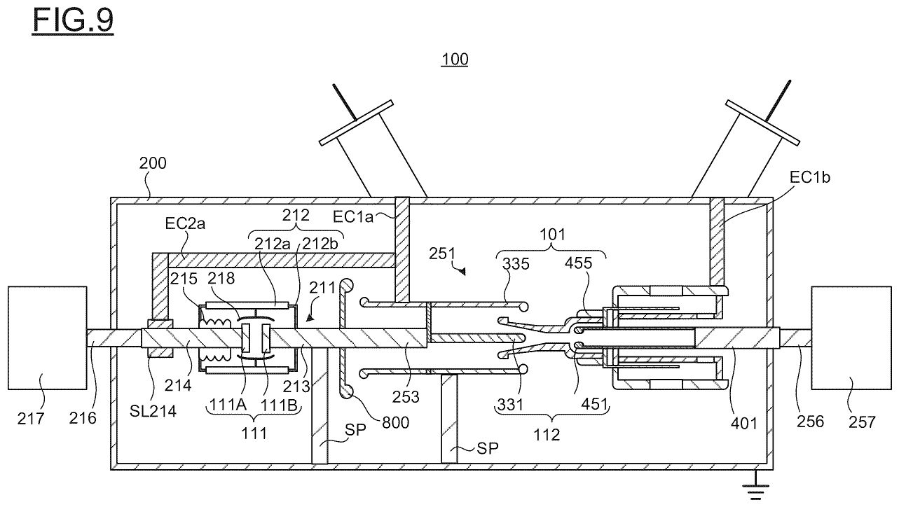

FIG. 9 is a cross-sectional view schematically illustrating a configuration of a circuit breaker device 100 according to a fourth embodiment. FIG. 9 illustrates the state where the circuit breaker device 100 is in the interrupted state.

As illustrated in FIG. 9, the circuit breaker device 100 in this embodiment includes a shield 800, which is different from the case of the second embodiment (see FIG. 4). Except for this point and related matters, the circuit breaker device 100 in this embodiment is the same as the case of the second embodiment (see FIG. 4). Therefore, explanations of overlapping matters will be omitted as appropriate.

As illustrated in FIG. 9, the shield 800 is installed inside the grounded tank 200 so as to be interposed between the vacuum circuit breaker 211 and the gas circuit breaker 251.

Specifically, the shield 800 is located closer to the gas circuit breaker 251 side than the support SP formed of an insulating material, between the vacuum circuit breaker 211 and the gas circuit breaker 251. The shield 800 has, for example, a ring shape and is installed so that the vacuum circuit breaker fixed current-carrying shaft 213 passes through its center, and the outer diameter of the shield 800 is larger than that of the insulating tube 212a constituting the vacuum vessel 212 of the vacuum circuit breaker 211.

The shield 800 is formed of a metal material and is installed so that an insulating state is maintained between the shield 800 and the gas circuit breaker 251. The end of the shield 800 is formed to have a curved shape in order to prevent dielectric breakdown from occurring between the shield 800 and a conductive material provided around the shield 800.

### [B] Summary

As explained in the second embodiment, during the interrupting process of transitioning from the current-carrying state to the interrupted state, the arc discharge AR occurs between the opposite-side arc contact 331 and the driving-side arc contact 451 in the gas circuit breaker 251 (see FIG. 6C). The arc discharge AR that has occurred is extinguished by the blowing of the insulating gas. Therefore, when metal vapor generated by the arc discharge AR travels from an open portion of the gas circuit breaker 251 (for example, inside of the cooling cylinder 301, or the like; see FIG. 6C) toward the vacuum circuit breaker 211 side and adheres to an insulator material constituting the vacuum circuit breaker 211, or the like, there is a possibility that the insulating performance may decrease.

However, in this embodiment, the shield 800 prevents the metal vapor generated by the arc discharge AR from traveling toward the vacuum circuit breaker 211 side. Therefore, in the circuit breaker device 100 in this embodiment, the decrease in insulating performance can be effectively inhibited.

Incidentally, in the above-described embodiment, the case where the shield 800 is provided in the case of the second embodiment (see FIG. 4) has been explained, but the present invention is not limited to this. The shield 800 may be provided also in the case of the third embodiment (see FIG. 7) similarly.

### Fifth Embodiment

### [A] Configuration of a Circuit Breaker Device 100

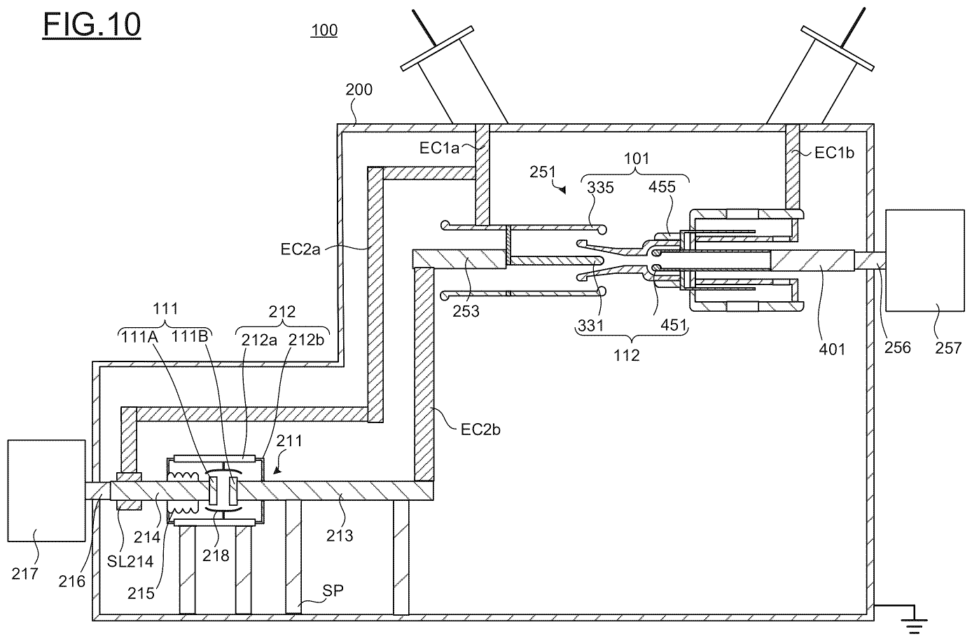

FIG. 10 is a cross-sectional view schematically illustrating a configuration of a circuit breaker device 100 according to a fifth embodiment. FIG. 10 illustrates the state where the circuit breaker device 100 is in the interrupted state.

As illustrated in FIG. 10, the circuit breaker device 100 in this embodiment is different from the case of the fourth embodiment (see FIG. 9) in that the shield 800 is not installed and in the arrangement relationship between the vacuum circuit breaker 211 and the gas circuit breaker 251. Except for this point and related matters, the circuit breaker device 100 in this embodiment is the same as the case of the fourth embodiment. Therefore, explanations of overlapping matters will be omitted as appropriate.

In this embodiment, as illustrated in FIG. 10, the vacuum circuit breaker movable current-carrying shaft 214 and the vacuum circuit breaker fixed current-carrying shaft 213 constituting the vacuum circuit breaker 211 are not aligned coaxially with the gas circuit breaker movable current-carrying shaft 401 and the gas circuit breaker fixed current-carrying shaft 253 constituting the gas circuit breaker 251, but are aligned along a different axis.

### [B] Summary

As explained in the fourth embodiment, during the interrupting process, when metal vapor generated by the arc discharge AR travels from the open portion of the gas circuit breaker 251 (for example, inside of the cooling cylinder 301, or the like; see FIG. 6C) toward the vacuum circuit breaker 211 side and adheres to the insulator material constituting the vacuum circuit breaker 211, or the like, there is a possibility that the insulating performance may decrease.

However, in this embodiment, the vacuum circuit breaker 211 is not located in the direction in which the metal vapor generated by the arc discharge AR travels, and there is no insulator material present there. Therefore, in the circuit breaker device 100 in this embodiment, the decrease in insulating performance can be effectively inhibited.

### Sixth Embodiment

### [A] Configuration of a Circuit Breaker Device 100

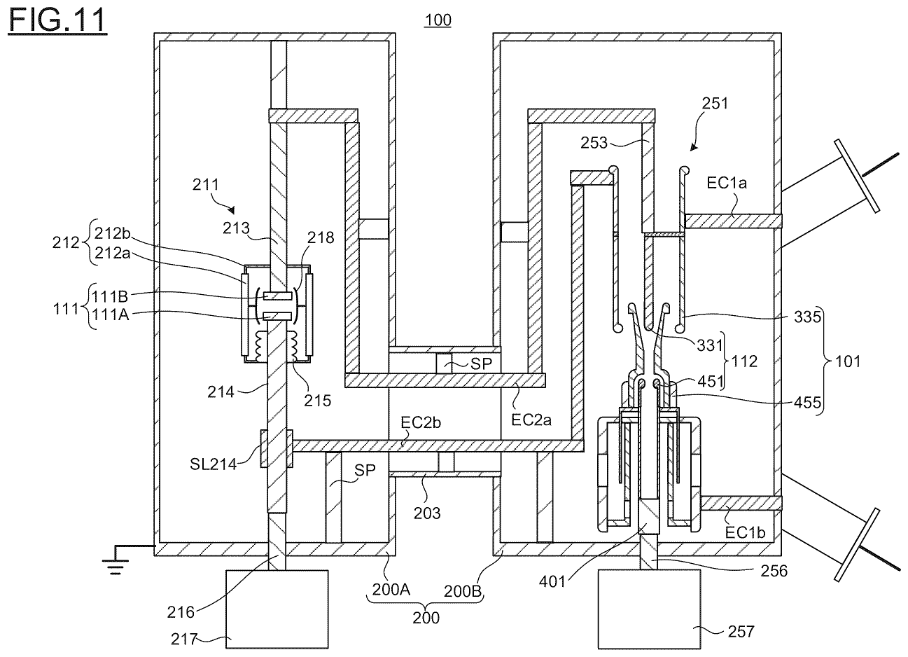

FIG. 11 is a cross-sectional view schematically illustrating a configuration of a circuit breaker device 100 according to a sixth embodiment. FIG. 11 illustrates the state where the circuit breaker device 100 is in the interrupted state.

As illustrated in FIG. 11, the circuit breaker device 100 in this embodiment is different from the case of the fifth embodiment (see FIG. 10) in the configuration of the grounded tank 200. Except for this point and related matters, the circuit breaker device 100 in this embodiment is the same as the case of the fifth embodiment. Therefore, explanations of overlapping matters will be omitted as appropriate.

In this embodiment, as illustrated in FIG. 11, the grounded tank 200 includes a first grounded tank part 200A, a second grounded tank part 200B, and a communication passage 203. The inside of the first grounded tank part 200A and the inside of the second grounded tank part 200B communicate with each other via the communication passage 203, and the pressure inside the first grounded tank part 200A and the pressure inside the second grounded tank part 200B are the same. The first grounded tank part 200A houses the vacuum circuit breaker 211 thereinside. The second grounded tank part 200B houses the gas circuit breaker 251 thereinside.

Further, in this embodiment, as illustrated in FIG. 11, the vacuum circuit breaker movable current-carrying shaft 214 and the vacuum circuit breaker fixed current-carrying shaft 213 constituting the vacuum circuit breaker 211 are not aligned coaxially with the gas circuit breaker movable current-carrying shaft 401 and the gas circuit breaker fixed current-carrying shaft 253 constituting the gas circuit breaker 251, but are aligned along a different axis.

### [B] Summary

As explained in the fifth embodiment, during the interrupting process, when metal vapor generated by the arc discharge AR travels from the open portion of the gas circuit breaker 251 (for example, inside of the cooling cylinder 301, or the like; see FIG. 6C) toward the vacuum circuit breaker 211 side and adheres to the insulator material constituting the vacuum circuit breaker 211, or the like, there is a possibility that the insulating performance may decrease.

However, in this embodiment, the vacuum circuit breaker 211 is not located in the direction in which the metal vapor generated by the arc discharge AR travels, and there is no insulator material present there. Therefore, in the circuit breaker device 100 in this embodiment, the decrease in insulating performance can be effectively inhibited.

### [C] Modified Example

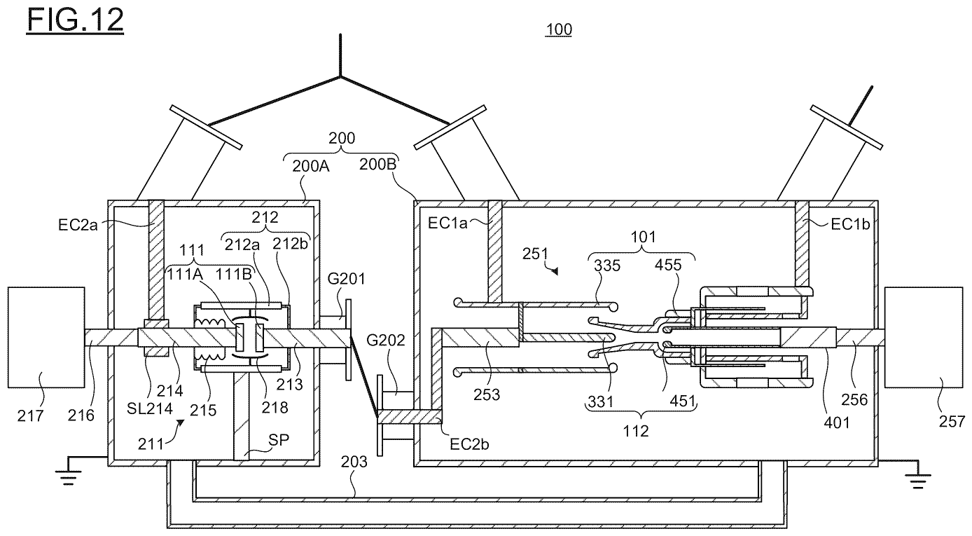

FIG. 12 is a cross-sectional view schematically illustrating a configuration of a circuit breaker device 100 according to a modified example of the sixth embodiment. FIG. 12 illustrates the state where the circuit breaker device 100 is in the interrupted state.

As illustrated in FIG. 12, in the circuit breaker device 100 in this modified example, the vacuum circuit breaker movable current-carrying shaft 214 and the vacuum circuit breaker fixed current-carrying shaft 213 constituting the vacuum circuit breaker 211 are aligned coaxially with the gas circuit breaker movable current-carrying shaft 401 and the gas circuit breaker fixed current-carrying shaft 253 constituting the gas circuit breaker 251. However, in this modified example, similarly to the case of the above-described embodiment, the vacuum circuit breaker 211 is housed inside the first grounded tank part 200A, and the gas circuit breaker 251 is housed inside the second grounded tank part 200B. Therefore, in this modified example, similarly to the case of the above-described embodiment, it is possible to easily prevent the metal vapor generated by the arc discharge AR from adhering to the insulator material constituting the vacuum circuit breaker 211, or the like.

Incidentally, in this modified example, the vacuum circuit breaker fixed current-carrying shaft 213 and the gas circuit breaker fixed current-carrying shaft 253 are electrically connected using a conductor in an insulator G201 installed outside the first grounded tank part 200A and a conductor in an insulator G202 installed outside the second grounded tank part 200B.

In this modified example, it is preferred that the end of the communication passage 203 (gas pipe) located on the side of the second grounded tank part 200B should not face the open portion of the gas circuit breaker 251, taking into consideration the travel of the metal vapor generated by the arc discharge AR. Similarly, it is preferred that the inner surface of the insulator G202 installed outside the second grounded tank part 200B should not face the open portion of the gas circuit breaker 251.

### Others

Although several embodiments of the present invention have been described, these embodiments are presented as examples, and are not intended to limit the scope of the invention. These embodiments can be implemented in various other forms, and various omissions, substitutions, and changes can be made without departing from the gist of the invention. These embodiments and their modifications are included in the scope and gist of the invention, and are included in the scope of the invention described in the claims and its equivalents.

### EXPLANATION OF REFERENCE SIGNS

3: opposite-side unit, 4: driving-side unit, 100: circuit breaker device, 101: current-carrying contact, 101A: gas circuit breaker movable electrode, 101B: gas circuit breaker fixed electrode, 111: first interrupting contact, 111A: movable electrode, 111B: fixed electrode, 112: second interrupting contact, 121A: movable electrode, 121B: fixed electrode, 200: grounded tank, 200A: first grounded tank part, 200B: second grounded tank part, 201: gas circuit breaker, 202: insulating gas vessel, 203: communication passage, 206: insulating rod, 207: operating mechanism, 211: vacuum circuit breaker, 212: vacuum vessel, 212a: insulating tube, 212b: flange, 213: vacuum circuit breaker fixed current-carrying shaft, 214: vacuum circuit breaker movable current-carrying shaft, 215: bellows, 216: insulating rod, 217: operating mechanism, 218: arc shield, 219a: sealing material, 221: vacuum circuit breaker, 222: vacuum vessel, 222a: insulating tube, 222b: flange, 223: vacuum circuit breaker fixed current-carrying shaft, 224: vacuum circuit breaker movable current-carrying shaft, 225: bellows, 226: insulating rod, 227: operating mechanism, 228: arc shield, 251: gas circuit breaker, 253: gas circuit breaker fixed current-carrying shaft, 256: insulating rod, 257: operating mechanism, 301: cooling cylinder, 302: support part, 303: opposite-side contact part, 321: support ring portion, 322: support protrusion, 331: opposite-side arc contact, 331a: end, 335: opposite-side current-carrying contact, 335a: end, 401: gas circuit breaker movable current-carrying shaft, 402: puffer cylinder, 403: puffer piston, 405: driving-side contact part, 406: cylinder support, 407: piston support, 411: movable current-carrying shaft solid portion, 412: movable current-carrying shaft hollow portion, 421: cylinder cylindrical tubular portion, 422: cylinder bottom plate portion, 451: driving-side arc contact, 451a: end, 455: driving-side current-carrying contact, 455a: end, 461: cylinder support cylindrical tubular portion, 462: cylinder support ring portion, 471: piston support cylindrical tubular portion, 472: piston support ring portion, 500: insulating nozzle, 510: nozzle large diameter portion, 520: nozzle small diameter portion, 530: nozzle inclined portion, 530a: end, 700: vacuum circuit breaker housing vessel, 800: shield, AR: arc discharge, DS: driving side, EC: electric circuit, EC1: current-carrying electric circuit, EC1a: electric wire, EC1b: electric wire, EC2: interrupting electric circuit, EC2a: electric wire, EC2b: electric wire, G201: insulator, G202: insulator, H412: first ventilation hole, H422a: rod through hole, H422b: exhaust hole, H461: second ventilation hole, H471: third ventilation hole, OS: opposite side, PR: puffer chamber, S500: nozzle internal space, SL101A: sliding part, SL214: sliding part, SL224: sliding part, SP: support

What is claimed is:

1. A circuit breaker device for switching an electric circuit from a current-carrying state to an interrupted state, the device comprising:
a current-carrying contact;
a first interrupting contact connected in parallel with the current-carrying contact; and
a second interrupting contact connected in parallel with the current-carrying contact and also connected in series with the first interrupting contact, wherein
a resistance of the current-carrying contact is smaller than a resistance of the first interrupting contact and a resistance of the second interrupting contact,
in the current-carrying state, the current-carrying contact, the first interrupting contact, and the second interrupting contact are in a closed state, and a larger current flows through the current-carrying contact than through the first interrupting contact and the second interrupting contact,
in the interrupted state, the first interrupting contact and the second interrupting contact are configured to switch from the closed state to an open state after the current-carrying contact switches from the closed state to the open state, and
at least one of the first interrupting contact and the second interrupting contact is constituted by a vacuum circuit breaker in which the closed state and the open state are switched inside a vacuum vessel.

2. The circuit breaker device according to claim 1, further comprising:
a grounded tank, wherein
the grounded tank houses, as the vacuum circuit breaker,
a first vacuum circuit breaker constituting the first interrupting contact and
a second vacuum circuit breaker constituting the second interrupting contact,
the first vacuum circuit breaker includes: as the first interrupting contact,
a first movable electrode installed on a first vacuum circuit breaker movable current-carrying shaft; and
a first fixed electrode installed on a first vacuum circuit breaker fixed current-carrying shaft aligned coaxially with the first vacuum circuit breaker movable current-carrying shaft, and
the first vacuum circuit breaker is configured to enter the closed state by establishing a contact state between the first movable electrode and the first fixed electrode, and to enter the open state by establishing a separate state between the first movable electrode and the first fixed electrode, and
the second vacuum circuit breaker includes: as the second interrupting contact,
a second movable electrode installed on a second vacuum circuit breaker movable current-carrying shaft; and
a second fixed electrode installed on a second vacuum circuit breaker fixed current-carrying shaft aligned coaxially with the second vacuum circuit breaker movable current-carrying shaft, and
the second vacuum circuit breaker is configured to enter the closed state by establishing a contact state between the second movable electrode and the second fixed electrode, and to enter the open state by establishing a separate state between the second movable electrode and the second fixed electrode.

3. The circuit breaker device according to claim 2, wherein
the current-carrying contact is constituted by a gas circuit breaker in which the closed state and the open state are switched in an atmosphere filled with an insulating gas, and
the grounded tank houses the gas circuit breaker thereinside.

4. The circuit breaker device according to claim 1, wherein
the first interrupting contact is constituted by the vacuum circuit breaker,
the vacuum circuit breaker is housed in a grounded tank filled with an insulating gas, and
the current-carrying contact and the second interrupting contact are constituted by a gas circuit breaker in which the closed state and the open state are switched inside the grounded tank.

5. The circuit breaker device according to claim 4, wherein
the vacuum circuit breaker includes:
a movable electrode installed on a vacuum circuit breaker movable current-carrying shaft; and
a fixed electrode installed on a vacuum circuit breaker fixed current-carrying shaft aligned coaxially with the vacuum circuit breaker movable current-carrying shaft,
the gas circuit breaker includes:
a gas circuit breaker movable current-carrying shaft on which a driving-side arc contact and a driving-side current-carrying contact are installed; and
a gas circuit breaker fixed current-carrying shaft that is aligned coaxially with the gas circuit breaker movable current-carrying shaft and on which an opposite-side arc contact and an opposite-side current-carrying contact are installed,
the current-carrying contact is configured to enter the closed state by establishing a contact state between the driving-side current-carrying contact and the opposite-side current-carrying contact, and
to enter the open state by establishing a separate state between the driving-side current-carrying contact and the opposite-side current-carrying contact,
the first interrupting contact is configured to enter the closed state by establishing a contact state between the movable electrode and the fixed electrode, and
to enter the open state by establishing a separate state between the movable electrode and the fixed electrode, and
the second interrupting contact is configured to enter the closed state by establishing a contact state between the driving-side arc contact and the opposite-side arc contact, and
to enter the open state by establishing a separate state between the driving-side arc contact and the opposite-side arc contact.

6. The circuit breaker device according to claim 4, further comprising:
a vacuum circuit breaker housing vessel that houses thereinside the vacuum circuit breaker, inside the grounded tank, wherein
a pressure inside the vacuum circuit breaker housing vessel is lower than a pressure inside the grounded tank and higher than a pressure inside the vacuum vessel.

7. The circuit breaker device according to claim 4, further comprising:
a shield installed inside the grounded tank so as to be interposed between the vacuum circuit breaker and the gas circuit breaker.

8. The circuit breaker device according to claim 5, wherein
the vacuum circuit breaker movable current-carrying shaft and the vacuum circuit breaker fixed current-carrying shaft are aligned along an axis different from an axis of the gas circuit breaker movable current-carrying shaft and the gas circuit breaker fixed current-carrying shaft.

9. The circuit breaker device according to claim 4, wherein
the grounded tank includes:
a first grounded tank part that houses the vacuum circuit breaker thereinside; and
a second grounded tank part that houses the gas circuit breaker thereinside, and
an inside of the first grounded tank part and an inside of the second grounded tank part communicate with each other via a communication passage.
